(19) United States
(12) Patent Application Publication
(10) Pub. No.: US 2004/0025646 A1
(43) Pub. Date: Feb. 12, 2004

(54) Multiple function adjustable wrench

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,386

(22) Filed: Aug. 12, 2002

(51) Int. Cl. B25B 13/00

(52) U.S. Cl. 81/125.1

(57) ABSTRACT

An adjustable wrench includes a shank having a first end with a fixed jaw and a movable jaw which is controlled by an adjusting member and movable relative to the fixed jaw. A recess is defined in at least one of two sides of a second end of the shank and an engaging member is rotatably received in the recess and teeth are defined in an inner periphery of the engaging member. A ratchet mechanism may be received in the shank and is cooperated with the engaging member.

### FIELD OF THE INVENTION

The present invention relates to a multiple function adjustable wrench that has an box end cooperated with a ratchet mechanism at a remote end of the wrench so as to have multiple functions.

### BACKGROUND OF THE INVENTION

A conventional adjustable wrench generally includes a shank and a fixed jaw which is fixedly connected to the shank and a movable jaw is movably engaged with a groove. The movable jaw is moved toward or away from the fixed jaw by rotating a threaded adjusting member such that the width between the fixed jaw and the movable jaw can be changed to meet the desired width of an object to be tightened or loosened. However, when the wrench is used in a narrow space, after the object is rotated an angle, the wrench has to be disengaged from the object and remounted the object at a suitable or convenient angle for the user to rotate the shank of the wrench. This takes a lot of time and the adjusting member is difficult to be rotated if the user's hand being attached with grease.

The present invention intends to provide a multiple adjusting function wrench that has a box end with several stages of ratchet engaging teeth which is conveniently to use.

### SUMMARY OF THE INVENTION

In accordance with one aspect of the present invention, there is provided an adjustable wrench which comprises a shank having a first end with a fixed jaw and a movable jaw which is movable relative to the fixed jaw by operating an adjusting member. A recess is defined in a first side of a second end of the shank and an engaging member is rotatably engaged with the first recess. Teeth are defined in an inner periphery of the first engaging member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the adjustable wrench of the present invention;

FIG. 2 shows two plan views of the adjustable wrench of the present invention;

FIG. 3 shows a bolt is engaged with the engaging member of the adjustable wrench of the present invention, and

FIG. 4 shows a smaller bolt is engaged with the engaging member and clamped by the jaws respectively.

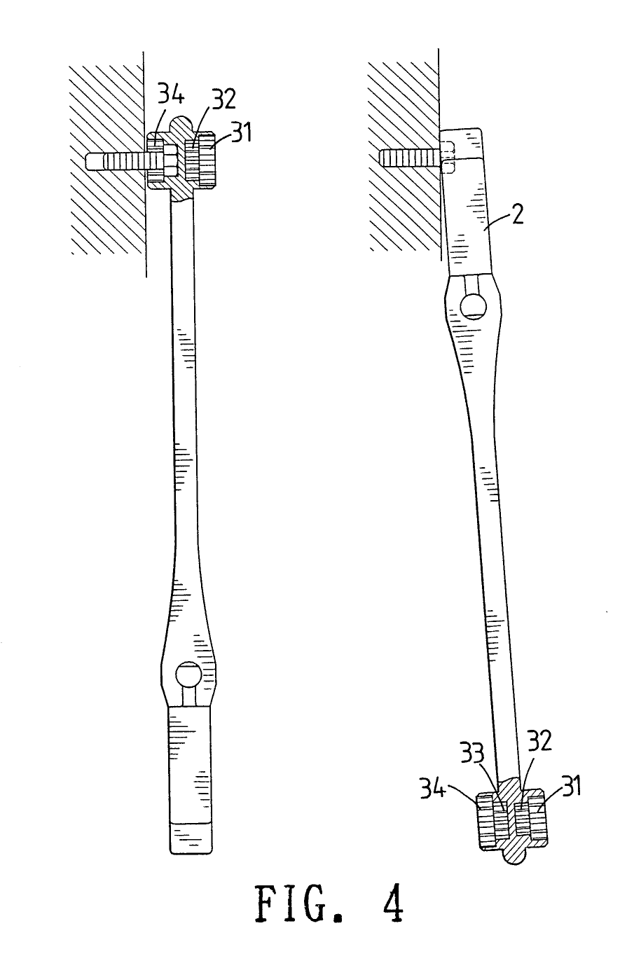

### DETAILED DESCRIPTION OF THE PREFERRED EMBODIMENT

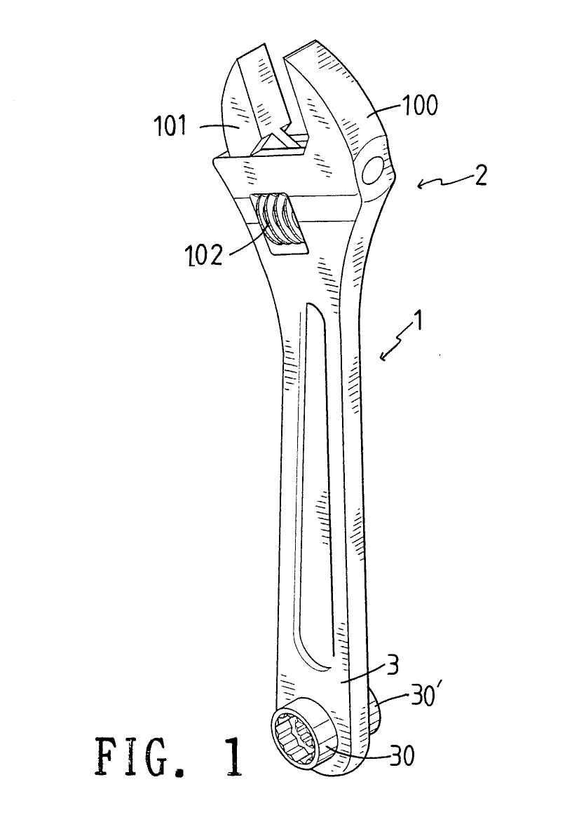

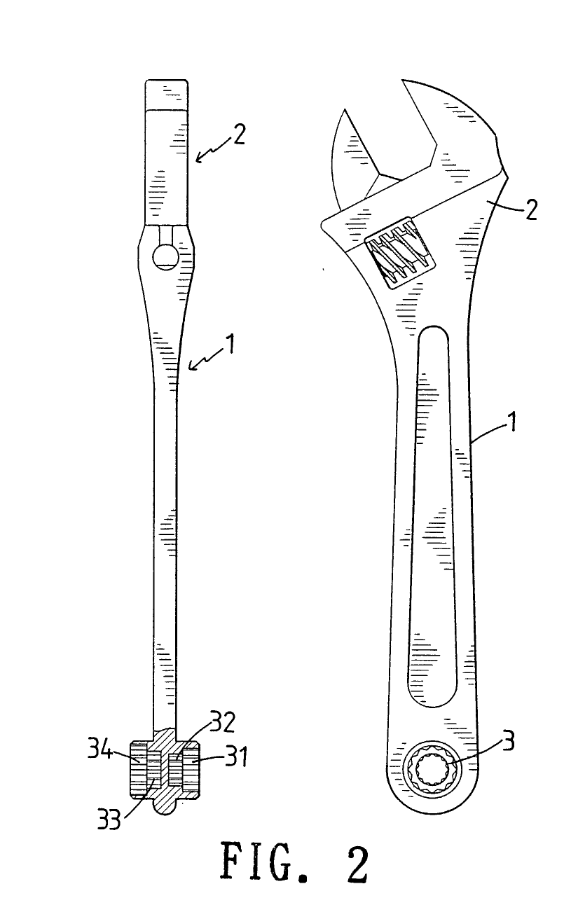

Referring to FIGS. 1 and 2, the multiple function adjustable wrench of the present invention comprises a shank 1 having a first end 2 with a fixed jaw 100 and a movable jaw 101 which is movable relative to the fixed jaw 100. An adjusting member 102 is cooperated with the movable jaw 101 and is rotated to drive the movable jaw 101.

A first recess defined in a first side of a second end 3 of the shank 1 and a first engaging member 30 is rotatably engaged with the first recess. A ratchet mechanism (not shown) is received in the second end 3 of the shank 1 so as to be cooperated with the first engaging member 30. The first engaging member 30 has two co-axial inner peripheries having different diameters and teeth 31, 32 are defined in each of the two inner peripheries.

A second recess is defined in a second side of the second end 3 of the shank 1 and a second engaging member 30′ is rotatably engaged with the second recess. The second engaging member 30′ is also engaged with the ratchet mechanism (not shown). The second engaging member 30′ has two co-axial inner peripheries having different diameters and teeth 33, 34 are defined in each of the two inner peripheries.

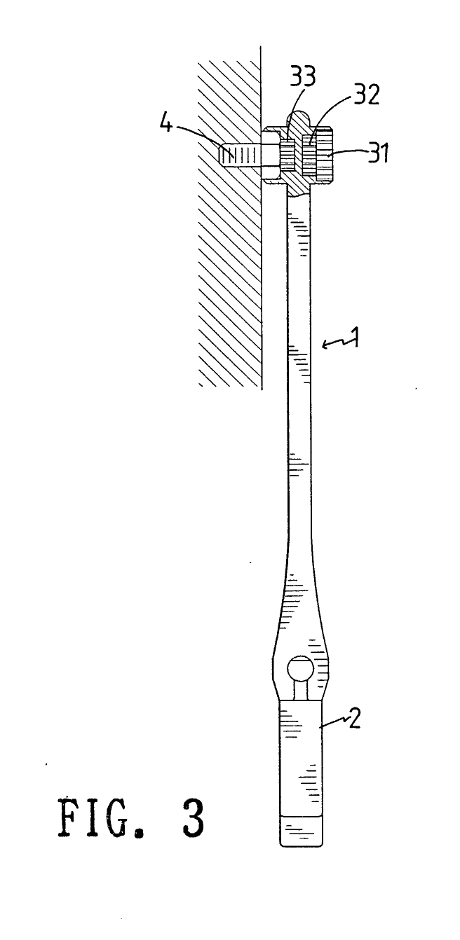

As shown in FIG. 3, a head of a bolt 4 can be engaged with one of the teeth such as the teeth 33 as shown and can be easily rotated. The diameters of the engaging members 30, 30′ have four different sizes so as to engage bolts with different sizes.

While we have shown and described the embodiment in accordance with the present invention, it should be clear to those skilled in the art that further embodiments may be made without departing from the scope of the present invention.

What is claimed is:

1. An adjustable wrench comprising:
a shank having a first end with a fixed jaw and a movable jaw which is movable relative to the fixed jaw, an adjusting member which is cooperated with the movable jaw, and
a first recess defined in a first side of a second end of the shank and a first engaging member rotatably engaged with the first recess, teeth defined in an inner periphery of the first engaging member.

2. The wrench as claimed in claim 1, wherein the first engaging member has two co-axial inner peripheries having different diameters and teeth are defined in each of the two inner peripheries.

3. The wrench as claimed in claim 1 further comprising a second recess defined in a second side of the second end of the shank and a second engaging member rotatably engaged with the second recess, teeth defined in an inner periphery of the second engaging member.

4. The wrench as claimed in claim 3, wherein the second engaging member has two co-axial inner peripheries having different diameters and teeth are defined in each of the two inner peripheries.
